(19) United States
(12) Patent Application Publication
(10) Pub. No.: US 2010/0215819 A1
(43) Pub. Date: Aug. 26, 2010

(54) USE OF ANIONIC EMULSIFIERS FOR INCREASING THE FIRMNESS OF PROCESSED CHEESE PRODUCTS WITH A SOLIDS CONTENT LESS THAN OR EQUAL TO 40%

(75) Inventor: Remy Manera, Saint-Agnes (FR)

Correspondence Address: YOUNG & THOMPSON, 209 Madison Street, Suite 500, Alexandria, VA, 22314, US

(73) Assignee: FROMAGERIES BEL, Paris (FR)

(21) Appl. No.: 12/682,257

(22) PCT Filed: Oct. 9, 2008
(86) PCT No.: PCT/FR2008/051837

§ 371 Date: Apr. 9, 2010

(30) Foreign Application Priority Data
Oct. 11, 2007 (FR) 0758216

(51) Int. Cl. A23C 19/08; A23C 19/082; A23C 19/084

(52) U.S. Cl. 426/334; 426/582

(57) ABSTRACT

The invention relates to the use of at least one anionic emulsifier, in particular a monoglyceride esterified with an organic acid, or an ester of a lactic acid esterified with fatty acids, in the preparation of a processed cheese with a solids content ≦40%, for increasing the firmness of the processed cheese product. The invention also relates to processed cheese products with a solids content ≦40% and including an anionic emulsifier, and also to a method for the production of such processed cheeses products.

The invention relates to the use of anionic emulsifiers in the preparation of processed cheese with a solids content ≦40% in order to increase the firmness of said processed cheese.

The invention also relates to processed cheeses with a solids content ≦40% containing at least one anionic emulsifier and also the method for manufacturing such processed cheeses.

“Processed cheeses”, or “processed cheese specialities” are products obtained by processing cheeses, using thermal treatment, and usually under partial vacuum, with or without melting salts.

The cheeses which constitute the raw material used in processing can be any kind of natural cheeses, in other words, cheeses obtained directly by coagulation of milk and/or of milk concentrates (initial transformation of the milk or milk concentrates). More generally, it involves pressed cheeses.

Processed cheeses may also include other dairy products such as milk protein concentrates and/or whey protein concentrates in liquid or powder form, whole, semi-skimmed or skimmed milk powder, animal fat (anhydrous milk fat, butter, cream) and/or vegetable fat (fat from, for example, soya, rapeseed, peanuts, sunflowers, palm oil, palm kernel oil, coconut oil). The method for manufacturing such products is described, for example, in the book “Le Fromage” by A. Eck (pub. Lavoisier, 1997, p. 691 ff).

Processed cheeses are mainly presented in trays or in the form of portions for spreading purposes, in slices for use in snacks or for culinary use, or in blocks for slicing or grating.

The invention relates more specifically to products for spreading.

Processed cheeses of the type for spreading are homogeneous, stable emulsions; the products have a shelf life which may be as long as one year, with prolonged unrefrigerated (room temperature) periods.

In general, the processed cheeses on the market are characterised by a solids content in the range:

34 to 55%, for products with a fat in solids content in the range 40 to 60% and a protein content in the range 9 to 15%.

40 to 55% for products with a fat in solids content in the range 60-70%, and a protein content in the range 8 to 12%.

30 to 40% for low-fat products, in other words, those with a fat in solids content in the range 20 to 30% and a protein content in the range 12 to 17%.

These processed cheeses are characterised by a relatively firm consistency, and are generally firmer the higher the solids content, and thus the protein content, whilst retaining their spreadability and their ability to melt in the mouth.

As an example, the consistency for products with a solids content of 40% and a fat in solids content of 46%, measured at 20° C., 8 days after manufacture, by a penetrometry test using an LFRA-STEVENS texture analyzer (Equipements Scientifiques, France) (probe diameter 6.35 mm/7 mm travel/penetration rate of 0.2 mm/s) is in the range 30 to 50 grams.

However, in formulas with a lower solids content, which is the case for low-fat products and particularly for formulas called “economical” (that is, with a reduced protein content), firmness is reduced. Processed cheeses are softer and may stick to the packaging (especially portions packaged in aluminum or products in trays or glass jars).

Moreover, in the context of new nutritional policies which aim at reducing consumers' intake of fats in order to combat obesity, the manufacture of good-quality low-fat products, with good organoleptic (texture) and functional (spreadability) characteristics, is particularly attractive. Furthermore, it is important to offer processed cheeses bringing the nutritional elements normally found in cheese (proteins, fats, calcium) at a moderate price for groups of people with low purchasing power, and to do so whilst reducing the solids content of the cheeses by reducing the content of the different elements of which proteins are one. It is nevertheless important, for products belonging to these two categories, to obtain processed cheeses that are firmer but which still melt in the mouth.

Although the use of conventional texturizing agents, such as hydrocolloids (carrageenans, guar or carob gums), enables the problem of firmness to be solved, processed cheeses obtained in this way have a jellified texture which is not very favourable to spreadability.

The applicant has unexpectedly shown that it is possible to obtain processed cheeses with a low solids content (that is, with a reduced fat and/or protein content) which nevertheless has good firmness, good creaminess in melting in the mouth and good spreadability through the use of emulsifiers belonging to the family of anionic emulsifiers.

Anionic emulsifier means a molecule with an amphiphilic character, whose hydrophilic part contains a negatively charged ionized group.

Within this family the following will be particularly suitable:

a) monoglycerides esterified with an organic acid, more specifically ACETEM (acetic acid esters of monoglycerides), CITREM (citric acid esters of monoglycerides), LACTEM (lactic acid esters of monoglycerides), DATEM (diacetyl tartaric acid esters of monoglycerides, additive E472e);

b) fatty acid esters of lactic acid, more specifically sodium stearoyl lactylates (SSL=E481) or calcium stearoyl lactylates (CSL=E482);

c) or a mixture thereof.

These emulsifiers are sold in powder or paste form. More specifically, mention can be made as diacetyl tartaric acid ester of monoglycerides (DATEM) of the one sold by the company DANISCO under the trade mark Panodan® (containing 80% DATEM and 20% calcium carbonate).

Mention can be made, as CSL and SSL, of those supplied by the firm KERRY under the trade marks Admul CSL 2010 (including 4% calcium) and Admul SSL 1078K (including 4% sodium) respectively.

DATEM is known to have greater hydrophilic properties than other emulsifiers derived from monoglycerides, these anionic properties making it very reactive with proteins, hence its use in protein emulsions. This emulsifier is particularly well-known for:

improving the volume of products and the machinability of doughs, hence its use in bread-making to improve, amongst other things, the volume of the breads;

withstanding high-temperature heat treatments, such as UHT treatment, or even sterilisation treatments. This product is therefore used in the field of emulsions such as hot or cold sauces, and mayonnaises, to improve the stability of the emulsions to heat treatments. In the context of this application, there can be cited patent EP 0716811 which describes the use of this emulsifier in sauces, mayonnaises and products for spreading where it is used to stabilise egg yolk during high-temperature heat treatments. There can also be cited patent EP 0702902 which describes a method for manufacturing a heat-stable oil-in-water emulsion that contains 0.1 to 5% DATEM as a substitute for egg yolk in sauces or mayonnaises containing vinegar.

The use of monoglycerides in processed cheeses has likewise been described, but for specific reasons. Patent application EP 0382291 thus describes that the use of monoglycerides, diglycerides and/or phosphatides makes it possible to limit the salting-out of fat in processed cheese formulations containing vegetable fat. However, no mention is made of the use of these emulsifiers to improve the firmness of processed cheeses with a low solids content.

SSL and CSL are prepared by esterification of lactic acid with a mixture of fatty acids (palmitic acid and stearic acid in a proportion of 1:1) in the presence of calcium hydroxide (CSL) or sodium hydroxide (SSL).

SSL is a universal, anionic emulsifier which disperses in water and which is widely used in baking/bread-making and for oil-in-water emulsions. It is used more frequently than CSL, which is also used in baking/bread-making.

It is not described that fatty acid esters of lactic acid improve the firmness of processed cheeses with a low solids content (<45%, preferably ≦40%, or even <40%). Lee Bou, in a thesis on “I'étude biochimique de la fonte des fromages” [biochemical study of the processing of cheeses] (University of Nancy—2001) described the substitution of stearoyl lactylate or saccharose esters for melting salts, for a role for destructuring cheeses with a view to processing; the results proved negative, as this family of emulsifiers had not played a role in destructuring the cheeses.

The use of anionic emulsifiers has been described in other documents for their use in the manufacture of processed cheese but for specific applications and functions.

Thus, U.S. Pat. No. 6,368,653 mentions the use of mesomorphic phases including an edible emulsifier during the manufacture of cheese products, in particular to replace fat. U.S. Pat. No. 6,368,653 describes the example of the preparation of a processed cheese with a solids content >40% and a fat in solids content <20% and containing 2% monoglycerides.

No mention is made of the use of these mesomorphic phases in processed cheeses with a low solids content (<45%, preferably ≦40%, or even <40%) to improve the viscosity of same and as a partial substitute for proteins.

Furthermore, U.S. Pat. No. 3,697,292 describes the use of monoglyceride esters in the manufacture of processed cheeses but for the purpose of increasing the quantities of reworked cheese within the processing formulas, insofar as the objective is to recycle previously-processed cheeses in said formulas. The monoglyceride esters, including DATEM, are used to eliminate the disadvantages related to the use of significant quantities of reworked cheese, which can be as high as 100% of the formulas, and more specifically the thickening of the products during heat treatment, which limits the pumpability of the product during dispensing operations. Furthermore, in the method of the present invention, when reworked cheese is used in the manufacture of processed cheese, it is used as a processing aid to facilitate the start of “creaming” (increase in viscosity). The reworked cheese is then incorporated at rates less than 5% by weight of the formula.

Thus, none of these documents mentions the role of these anionic emulsifiers as protein substitutes in economical formulas in order to improve the firmness of formulas with a low solids content ≦40%).

Unexpectedly, the anionic emulsifiers of the invention, in particular DATEM, SSL or CSL, make it possible to increase the viscosity of formulas with a low solids content in which they can replace proteins, thus making it possible to reduce the total protein content of the formulas to 30%.

Furthermore, the applicant has unexpectedly shown that the action of the family of anionic emulsifiers was improved synergistically in the presence of hydrocolloids, more specifically of carrageenans.

### Use of an Anionic Emulsifier to Increase the Firmness of Processed Cheeses with a Solids Content ≦40%

The invention relates to the use of at least one anionic emulsifier in the preparation of processed cheese with a solids content ≦40%, preferably <40%, in order to increase the viscosity or firmness of said processed cheese.

Processed cheeses obtained according to the invention have a solids content preferably ≦37%, more specifically ≦37% if the fat in solids content is in the range 5 to 50%. Preferably, said processed cheese has a fat in solids content in the range 5 to 70%, and preferably again in the range 5 to 55% (range limits included).

Processed cheeses according to the present invention relate more specifically to cheeses with solids and fats characteristics (expressed as fat in solids content) as follows:

solids content ≦33% for a fat in solids content in the range 5 to 30%

solids content ≦37%, preferably 33%<solids content ≦37%, for a fat in solids content in the range 30 to 50%

solids content ≦40%, preferably 37%<solids content ≦40%, for a fat in solids content in the range 50 to 70%

More specifically, within the family of anionic emulsifiers, monoglycerides esterified with an organic acid and esters of a lactic acid esterified with fatty acids, or a mixture thereof, will be chosen.

Monoglycerides esterified with an acid are the most commonly-used emulsifying agents in the world, this family of additives includes: ACETEM (acetic acid esters of monoglycerides), CITREM (citric acid esters of monoglycerides), LACTEM (lactic acid esters of monoglycerides), DATEM (diacetyl tartaric acid esters of monoglycerides).

The invention preferably relates to the specific use of DATEM.

According to the results of comparative penetrometry tests carried out by the applicant on processed cheeses containing, or not containing, an organic acid ester of monoglyceride, the increase in firmness between a control processed cheese and a processed cheese made with 0.48% DATEM is of at least 20%.

“Penetrometry” is the measurement of the resistance of an object to continuous penetration by a rod of a given cylindrical cross-section, at a given speed of penetration and a given distance of travel. In the context of the present application, penetrometry is measured using an LFRA-STEVENS texture analyzer (Equipements Scientifiques, France) with a probe of 6.35 mm in diameter, a penetration depth of 7 mm at a speed of 0.2 mm/s, at 20° C.

Among esters of lactic acid esterified with fatty acids, the preference will be for esters of lactic acid esterified by palmitic acid and stearic acid in the presence of sodium hydroxide or calcium hydroxide, and more specifically sodium stearoyl lactylates (SSL) and calcium stearoyl lactylates (CSL).

According to the results of comparative penetrometry tests carried out by the applicant on processed cheeses incorporating, or not, CSL or SSL, the increase in firmness between a control processed cheese and a processed cheese made with 0.20% SSL or CSL is of 25%.

The content of said anionic emulsifier, in particular of a monoglyceride esterified with an organic acid or an ester of a lactic acid esterified with fatty acids, and in particular of DATEM, SSL or CSL, in the mixture of ingredients used to prepare said processed cheese may be of at least 0.05%, preferably from 0.05 to 1%, preferably 0.1 to 1%, still preferably from 0.1 to 0.8%, still preferably from 0.2 to 0.6%, by weight relative to the total weight of the mixture.

The invention also relates to the use of these anionic emulsifiers in association with hydrocolloids, in particular but not exclusively carrageenans. Indeed, a synergistic improvement in firmness is observed when DATEM, CSL or SSL are used in combination with one or more hydrocolloids such as carrageenans.

The carrageenans may be incorporated into the mixture of ingredients used to prepare the processed cheese in a proportion ranging from 0.05 to 5%, preferably from 0.1 to 3%, still preferably from 0.1 to 1%, by weight relative to the total weight of the mixture.

Preferably, the firmness of a processed cheese according to the invention, measured by penetrometry, is higher by at least 5 grams, preferably 10 grams and preferably again by at least 20 grams, compared with a control processed cheese produced under the same conditions but without any monoglyceride esterified by an acid, and in particular without DATEM, and/or without any ester of lactic acid esterified with fatty acids, in particular without CSL or SSL.

### Method for the Manufacture of Processed Cheeses with a Solids Content ≦40%

The invention also relates to a method for the manufacture of a processed cheese with a solids content ≦40%, preferably <40%, said method including the steps consisting in:

a) obtaining a mixture comprising, by weight relative to the total weight of the mixture:

at least 5%, preferably 5 to 50%, still preferably 10 to 40%, still preferably 10 to 30%, of at least one natural cheese;

0 to 50%, preferably 5 to 30%, still preferably 10 to 20%, still preferably 10 to 15%, of at least one fat;

0 to 40%, preferably 5 to 20%, still preferably 10 to 15%, of at least one compound selected from a group consisting of whole milk powder and/or semi-skimmed or skimmed milk powder, whey powder, caseins;

0 to 20%, preferably 1 to 10%, still preferably 1 to 5%, of milk protein concentrates and/or whey protein concentrates;

0 to 5%, preferably 0.5 to 3%, still preferably 1 to 2%, of at least one melting salt;

at least 0.05% of at least one anionic emulsifier, preferably 0.05% to 1%, preferably 0.1 to 1%, preferably 0.1 to 0.8%, still preferably 0.2 to 0.6%; and

sufficient water to make up to 100%;

b) processing the mixture using a thermomechanical treatment at a temperature ≧80° C. to obtain a processed cheese; and

c) optionally, cooling the processed cheese to a temperature of 70-100° C. and packaging the processed cheese.

The anionic emulsifier may be a monoglyceride esterified with an organic acid, in particular ACETEM, CITREM, LACTEM, or DATEM; preferably DATEM.

The anionic emulsifier may be an ester of a lactic acid esterified with fatty acids, preferably an ester of lactic acid esterified by palmitic acid and stearic acid in the presence of sodium hydroxide or calcium hydroxide, and more preferably SSL or CSL.

The natural cheese incorporated into the mixture of ingredients for preparation of the processed cheese according to the invention may be any cheese coming from an initial transformation of milk or milk concentrates, by enzymatic and/or acid coagulation of the milk or milk concentrates.

Often, different natural cheeses are mixed to prepare the processed cheese, these cheeses can be selected according to their type, taste, maturity, consistency or acidity, for example.

Generally, the natural cheese or cheeses used are pressed cheeses, and in particular uncooked pressed cheeses such as Gouda, Edam, Cheddar, Cantal, Raclette, or Morbier, or cooked pressed cheeses such as Emmental, Gruyère, Comté, or Beaufort. However, the natural cheeses used most often are Gouda, Edam, Cheddar, and Emmental.

The natural cheese may also be, or the mixture of natural cheeses may include a pulled-curd cheese such as Mozzarella.

Preferably, the size of the natural cheese or cheeses which form part of the mixture is reduced, possibly after derinding, by grating and/or grinding.

The natural cheese may possibly be, or the mixture may include, fresh curds or fermented milks such as yogurt, kefir, or labneh. These latter are preferred in the context of manufacturing products belonging to the processed fromage frais group. In this case, the natural cheese or mixture of natural cheeses may consist of fresh curds or fermented milks which then generally represent up to 80-85% of the mixture of ingredients to be processed. Fresh curds or fermented milks may also be mixed with natural pressed cheeses, in general constituting between 5 and 10% of the mixture of ingredients to be processed.

Preferably, the method according to the invention does not use reworked cheese. However, up to 5% of reworked cheese, by weight relative to the total weight of the mixture, may be incorporated as a processing aid to facilitate the start of creaming.

The mixture of ingredients may contain at least one fat, which may be one or more than one animal fat, such as butter, AMF (anhydrous milk fat), and cream, and/or one or more than one vegetable fat such as rapeseed, soya, peanut, sunflower, palm, palm kernel and coconut oils. The amount of animal and/or vegetable fat used depends on the desired fat content of the finished processed cheese.

The mixture may also contain milk powder, whey powder, caseins, which enables adding protein constituents to the processed cheese.

The use of non-cheese raw materials depends on their availability and their market price because they more or less partially replace the cheese part by their protein content. The person skilled in the art knows perfectly well how to adjust the quantity of different raw materials according to the finished product to be produced.

The mixture may advantageously also include 0.05 to 5%, preferably 0.1 to 3%, still preferably 0.1 to 1%, of at least one hydrocolloid, such as carrageenans, guar, carob or xanthan gum.

In particular, a synergistic effect of improving firmness is observed when DATEM or CSL or SSL are used in combination with one or more than one carrageenan.

Within the context of the invention, the anionic emulsifier is either added directly to the mixture before cooking (thermomechanical treatment), or, where fat is added, is incorporated beforehand into the fat which is itself to be incorporated into the mixture.

The anionic emulsifiers (monoglyceride esterified with an organic acid, in particular DATEM, or esters of lactic acid, in particular SSL or CSL) may be used in the presence of one or more than one conventional melting salt, such as phosphates and/or citrates of sodium, potassium or magnesium. The melting salts are preferably used in a proportion of 0.5 to 3% in the mixture of ingredients.

According to one embodiment, anionic emulsifiers are used without melting salt.

The mixture of ingredients for preparation of the processed cheese may also include, for example, seasonings, solid elements, or colourings.

“Solid elements” means elements which have a shape, texture, colour or taste which is recognisable within the cheese product. Examples of such solid elements include garlic, parsley, pepper, shallot, cumin, chopped walnuts, hazelnuts, olives, herbs, fruit or vegetable pieces.

More specifically, a mixture of ingredients according to the invention may comprise 10 to 30% of a mixture of natural cheeses, in particular of pressed cheeses; 10 to 15% of fat; 10 to 15% of at least one compound selected from the group consisting of whole milk powder and/or semi-skimmed or skimmed milk powder, whey powder, and caseins, in particular 10 to 15% of skimmed milk powder; 1 to 5% of milk protein concentrates and/or whey protein concentrates; 1 to 3% of melting salts; 0.2 to 0.6% of DATEM and sufficient water to make the mixture up to 100%. DATEM may be replaced by 0.2 to 0.6% of CSL or SSL.

A low-fat processed cheese according to the invention may be prepared from a mixture of ingredients comprising 10 to 30% of a mixture of natural cheeses, in particular of pressed cheeses; 10 to 15% of at least one compound selected from the group consisting of whole milk powder and/or semi-skimmed or skimmed milk powder, whey powder, and caseins, in particular, 10 to 15% of skimmed milk powder; 1 to 5% of milk protein concentrates and/or whey protein concentrates; 1 to 3% of melting salt(s); 0.2 to 0.6% of DATEM and sufficient water to make the mixture up to 100%. DATEM may be replaced by 0.2 to 0.6% of CSL or SSL.

Another mixture of ingredients according to the invention may comprise 10 to 30% of a mixture of natural cheeses, in particular of pressed cheeses; 10 to 15% of fat; 10 to 15% of at least one compound selected from the group consisting of whole milk powder and/or semi-skimmed or skimmed milk powder, whey powder, and caseins, in particular 10 to 15% of skimmed milk powder; 1 to 5% of milk protein concentrates and/or whey protein concentrates; 1 to 3% of melting salt(s), 0.3 to 0.6% of DATEM or 0.05 to 0.5% of CSL or SSL; 0.2 to 1% of at least one hydrocolloid and sufficient water to make the mixture up to 100%.

The thermomechanical treatment is carried out at a temperature ≧80° C., preferably at a temperature of 80-120° C., still preferably at 100-115° C., for a period ranging from a few seconds to several minutes, depending on the temperature used.

The processing of the mixture of ingredients is typically performed in a cutter-type apparatus (for example, those sold under the name STEPHAN®) or apparatus such as a dough mixer, blender, batch mixer, cooker-blender, kneader-extruder, or extruder. The thermomechanical treatment may be performed at speeds of up to 1500 rpm.

A homogeneous mixture is obtained at the end of the processing step.

The thermomechanical treatment is advantageously followed by Ultra-High Temperature (UHT) sterilisation at a temperature up to 150° C. and cooling to a temperature of 80-90° C. For example, the processed mixture may be treated in a UHT apparatus at 140° C. for 3 seconds, then flash-cooled to 80° C.

Where UHT sterilisation is used, sterilisation is then followed by a creaming step during which protein polymerisation reactions occur that lead to the structuring and thickening of the product. Creaming generally takes place in agitated reaction vessels, where the cheese typically remains for at least 10 minutes, preferably at least 15 minutes, at a temperature of 80-90° C. with agitation at approximately 20 rpm.

The products will be packaged before or after cooling in different types of packaging according to subsequent use and local custom (aluminum, trays, cups, glass jars or plastic containers, etc.).

Generally, the processed cheese is hot-packaged before being cooled, typically to 10-15° C., which confers an advantage in terms of food safety.

The processed cheeses obtained according to the invention have a solids content preferably ≦37%, more particularly ≦37% if the fat in solids content is in the range 5 to 50%. Preferably, said processed cheese has a fat in solids content in the range 5 to 70%, still preferably in the range 5 to 55% (range limits included).

More specifically, processed cheeses obtained by the method according to the invention may have the following solids and fats characteristics (expressed as fats in solids):

solids content ≦33% for a fat in solids content in the range 5 to 30%, or

solids content ≦37%, preferably 33%<solids content ≦37% for a fat in solids content in the range 30 to 50%, or

solids content ≦40%, preferably 37%<solids content ≦40% for a fat in solids content in the range 50 to 70%.

### Processed Cheeses with Solids Content ≦40%

The invention also relates to a processed cheese likely to be obtained by the method of manufacture according to the invention. According to one embodiment, the processed cheese has been prepared by the method of manufacture according to the invention.

The invention also relates to a processed cheese with a solids content ≦40%, preferably <40%, which contains proteins, fat and at least one anionic emulsifier, in particular a monoglyceride esterified with an organic acid or esters of lactic acid esterified by fatty acids as described above. Advantageously, these compounds may replace up to 30% of the quantity of proteins in the formulas for processed cheeses.

Preferably, said at least one monoglyceride esterified with an organic acid is a diacetyl tartaric acid ester of monoglyceride (DATEM).

Preferably, said at least one fatty acid ester of lactic acid is SSL or CSL.

The processed cheese according to the invention preferably has a minimum anionic emulsifier content of 0.05% by weight relative to the total weight of the processed cheese.

The content of said at least one anionic emulsifier, and in particular of DATEM, CSL or SSL, in the processed cheese is advantageously in the range 0.05 to 1%, preferably in the range 0.1 to 1%, preferably in the range 0.1 to 0.8%, still preferably in the range 0.2 to 0.6% by weight relative to the total weight of the processed cheese (range limits included).

The processed cheese may further include 0.05 to 5%, preferably 0.1 to 3%, still preferably 0.1 to 1%, of at least one hydrocolloid, such as carrageenans, guar, carob, or xanthan gum. Preferably, the hydrocolloid is one or more than one carrageenan.

The processed cheeses according to the invention have a solids content preferably ≦37%, more particularly ≦37% if the fat in solids content is in the range 5 to 50%. Preferably, said processed cheese has a fat in solids content in the range 5 to 70%, still preferably in the range 5 to 55% (range limits included).

More specifically, the processed cheeses according to the invention may have the following solids and fats characteristics (expressed as fat in solids):

solids content ≦33% for a fat in solids content in the range 5 to 30%, or

solids content ≦37%, preferably 33%<solids content ≦37% for a fat in solids content in the range 30 to 50%, or

solids content ≦40%, preferably 37%<solids content ≦40% for a fat in solids content in the range 50 to 70%.

The processed cheese according to the invention may include at least one conventional melting salt, such as phosphates and/or citrates of sodium, potassium or magnesium. The melting salts content of the processed cheese is typically in the range 0.5 to 3%, by weight relative to the total weight of the processed cheese. The melting salts content of the processed cheese may still be from 1 to 2%, by weight relative to the total weight of the processed cheese.

The processed cheese may also include in its formula seasonings, solid elements, colourings, etc.

“Solid elements”, means elements which have a shape, texture, colour or taste which is recognisable within the cheese product. Examples of such solid elements include garlic, parsley, pepper, shallot, cumin, chopped walnuts, hazelnuts, olives, herbs, fruit or vegetable pieces.

The examples presented herein below enable the person skilled in the art to understand the full advantage of using this family of emulsifiers to produce processed cheeses with a solids content ≦40%, more specifically ≦37%.

The use of DATEM or CSL or SSL, as shown by the examples, makes it possible to obtain products with a low solids content 40%) which have a firm texture whilst continuing to melt in the mouth and with good spreadability properties. The use of DATEM, SSL or CSL and more generally of anionic emulsifiers, is thus of particular value in the preparation of processed cheeses with low-fat or economical formulas, which would otherwise lack firmness.

Furthermore, they make it possible to replace 30%, preferably 20%, of the proteins (expressed as a total percentage of the proteins in the formula) in economical formulas.

### EXAMPLE 1

### Manufacture of a Processed Cheese with a Solids Content of 37%, a Fat Content of 45% (Expressed as Fat in Solids) and a Protein Content of 10%

A control formula (A) was prepared and also two other products, B, C, with the same composition except that the composition of B and C incorporated 0.3% and 0.6% PANODAN A2020 (Danisco) (in other words, 0.24% and 0.48% DATEM) (by weight relative to the total weight of the mixture).

In parallel, a formula D was prepared, identical to A except for the milk protein concentrates content and skimmed milk powder content which were changed to 5% and 7% respectively. The protein content of D was 11.5%.

| | % (by weight, relative to the total | | | |
|---|---|---|---|---|
| | weight of the mixture) | | | |
| Ingredients | A | B | C | D |
| Emmental | 8 | 8 | 8 | 8 |
| Cheddar | 10 | 10 | 10 | 10 |
| butter | 12.4 | 12.4 | 12.4 | 12.4 |
| skimmed milk | 10 | 10 | 10 | 7 |
| powder | | | | |
| milk protein | 2 | 2 | 2 | 5 |
| concentrates | | | | |
| sodium | 2 | 2 | 2 | 2 |
| polyphosphates | | | | |
| cooking salt | 0.4 | 0.4 | 0.4 | 0.4 |
| PANODAN A2020 | — | 0.3 | 0.6 | 0 |
| Water | to make up to | to make | to make up to | to make |
| | 100% | up to | 100% | up to |
| | | 100% | | 100% |

The ingredients were mixed in a (STEPHAN®) cutter, then treated in a UHT apparatus at 140° C. for 3 seconds, and flash-cooled to 85° C. The product then underwent a creaming step, 15 minutes at 85° C. and 20 rpm, before being hot-packaged in portions in aluminum.

The pH of the products was 5.5.

A penetrometry test was carried out on the 3 samples A, B and C, at D+7 (7 days after the manufacture of the products), at 20° C. using a STEVENS (Equipements Scientifiques, France) texture analyzer (probe diameter 6.35 mm/travel 7 mm/penetration rate 0.2 mm/s). The results were as follows:

A=28 g

B=52 g

C=61 g

D=51 g

The products were tasted by a panel of experts with the following results:

A=soft product which stuck in the mouth;

B=firm with melting texture;

C=firmer than B but melting texture;

D=firm (equivalent to B).

Furthermore, products B and C were more easily removed from the aluminum.

In conclusion, the products containing DATEM were firmer but had an extremely melting texture, not pasty and not sticky, which is not usual for products with this consistency.

Moreover, as shown by comparison by tests B and D, DATEM makes it possible to replace 3% of the milk protein concentrates of the mixture, in other words, 15% of the total percentage of proteins in the formulas, whilst retaining the product's organoleptic and textural characteristics.

### EXAMPLE 2

### Manufacture of Low-Fat Products

Using the same protocol as for example 1, three low-fat processed cheeses (solids content of 32% and fat in solids content of 25%) were made.

The composition of the products was similar to that of products A to C in example 1, except that butter was omitted. The control A was made without CSL and the 2 test products (B and C) were made with 0.2% and 0.6% of CSL (Admul 2010® produced by the company Kerry) respectively.

| | % (by weight, relative to the total | | |
|---|---|---|---|
| | weight of the mixture) | | |
| Ingredients | A | B | C |
| Emmental | 8 | 8 | 8 |
| Cheddar | 15 | 15 | 15 |
| skimmed milk | 10 | 10 | 10 |
| powder | | | |
| milk protein | 2 | 2 | 2 |
| concentrates | | | |
| sodium | 2 | 2 | 2 |
| polyphosphates | | | |
| cooking salt | 0.4 | 0.4 | 0.4 |
| Admul CSL 2010 | — | 0.2 | 0.6 |
| water | to make | to make | to make up to 100% |
| | up to 100% | up to 100% | |

The measurement results of the penetrometry tests, carried out on D+4 at 20° C. using a STEVENS (Equipements Scientifiques, France) texture analyzer (probe diameter 6.35 mm/travel 7 mm/penetration rate 0.2 mm/s), were 15, 24 and 29 grams for products A, B and C respectively.

When tasted, products B and C were considered to be firmer than A, and to have a melting texture.

### EXAMPLE 3

### Manufacture of “Economical” Products (Solids Content of 35% and Fat in Solids Content of 40%)

Again using the same protocol, processed cheeses called “economical” were made. For this purpose, butter was replaced by AMF (anhydrous milk fat) and 13% Cheddar, 2% casein and 10% low-fat skimmed milk powder were used as sources of protein.

The control A was made without DATEM but with 2% melting salts, for test B 0.2% carrageenans was added; for test C 0.4% PANODAN A2020 (Danisco) (0.32% DATEM) was added, and for test D 0.2% carrageenans and 0.4% PANODAN A2020 were added.

| | % (by weight, relative to the total | | | |
|---|---|---|---|---|
| | weight of the mixture) | | | |
| Ingredients | A | B | C | D |
| Cheddar | 13 | 13 | 13 | 13 |
| anhydrous milk | 12 | 12 | 12 | 12* |
| fat | | | | |
| skimmed milk | 10 | 10 | 10 | 10 |
| powder | | | | |
| casein | 2 | 2 | 2 | 2 |
| sodium | 2 | 3 | 2 | 2 |
| polyphosphates | | | | |
| cooking salt | 0.4 | 0.4 | 0.4 | 0.4 |
| carrageenans | — | 0.2 | — | 0.2 |
| PANODAN | — | — | 0.4 | 0.4 |
| A2020 | | | | |
| water | to make | to make | to make | to make |
| | up to 100% | up to 100% | up to 100% | up to 100% |

The measurement results of the penetrometry tests carried out on D+10 at 20° C. using a STEVENS texture analyzer (probe diameter 6.35 mm/travel 7 mm/penetration rate 0.2 mm/s), on products A to D were as follows:

A: 22 g

B: 25 g

C: 32 g

D: 44 g

Thus, these results show that the DATEM and the carrageenans synergistically improve the firmness of an economical product, with a low protein and solids content.

1-31. (canceled)

32. A method for the manufacture of a processed cheese with a solids content ≦40%, said method comprising the steps consisting of:
a) obtaining a mixture comprising, by weight relative to the total weight of the mixture:
at least 5% of at least one natural cheese;
0 to 50% of at least one fat;
0 to 40% of at least one compound selected from the group consisting of whole milk powder and/or semi-skimmed or skimmed milk powder, whey powder, and caseins;
0 to 20% of milk protein concentrates and/or whey protein concentrates;
0 to 5% of at least one melting salt;
0.05% to 1% of at least one anionic emulsifier, and
water to make the mixture up to 100%;
b) processing the mixture by thermomechanical treatment at a temperature ≧70° C. in order to obtain a processed cheese; and
c) optionally, cooling the processed cheese to 70-80° C. and packaging the processed cheese.

33. The method according to claim 32, wherein said mixture comprises 0.1 to 0.8% of at least one anionic emulsifier.

34. The method according to claim 32, wherein said mixture comprises 0.2 to 0.6% of at least one anionic emulsifier.

35. The method according to claim 32, wherein said anionic emulsifier is a monoglyceride esterified with an organic acid, or an ester of a lactic acid esterified with fatty acids, or a mixture thereof.

36. The method according to claim 32 wherein said anionic emulsifier is a diacetyl tartaric acid ester of mono/diglycerides (DATEM), a sodium stearoyl lactylate (SSL) or a calcium stearoyl lactylate (CSL).

37. The method according to claim 32, wherein said mixture comprises 5 to 50% of at least one natural cheese.

38. The method according to claim 32 wherein said mixture comprises 5 to 30% of at least one fat.

39. The method according to claim 32, wherein said mixture comprises 5 to 20% of at least one compound selected from the group consisting of whole milk powder and/or semi-skimmed or skimmed milk powder, whey powder, caseins.

40. The method according to claim 32, wherein said mixture comprises 1 to 10% milk protein concentrates and/or whey protein concentrates.

41. The method according to claim 32, wherein said mixture comprises 0.5 to 3% of at least one melting salt.

42. The method according to claim 32, wherein said mixture comprises 0.05 to 5% of at least one hydrocolloid.

43. The method according to claim 42, wherein said at least one hydrocolloid is one or more than one carrageenan.

44. The method according to claim 32, wherein said processed cheese has a solids content <40%.

45. The method according to claim 32, wherein said processed cheese has a fat in solids content in the range 5 to 70%.

46. A processed cheese likely to be obtained by the method of manufacture according to claim 32.

47. A processed cheese with a solids content ≦40% and which contains proteins, fat and 0.05 to 1%, by weight relative to the total weight of the processed cheese, of at least one anionic emulsifier.

48. A processed cheese likely to be obtained by the method of manufacture according to claim 32, which comprises 0.1 to 0.8%, by weight relative to the total weight of the processed cheese, of at least one anionic emulsifier.

49. The processed cheese according to claim 48, which comprises 0.2 to 0.6% of at least one anionic emulsifier.

50. The processed cheese according to claim 48, wherein said anionic emulsifier is a monoglyceride esterified with an organic acid, or an ester of a lactic acid esterified with fatty acids, or a mixture thereof.

51. The processed cheese according to claim 48 wherein said anionic emulsifier is a diacetyl tartaric acid ester of monoglyceride (DATEM), a sodium stearoyl lactylate (SSL) or a calcium stearoyl lactylate (CSL).

52. The processed cheese according to claim 46, which further comprises 0.05 to 5% of one or more than one carrageenan.

53. The processed cheese according to claim 46, said processed cheese having a solids content <40%.

54. The processed cheese according to claim 46, said processed cheese having a fat in solids content in the range 5 to 70%.

55. The processed cheese according to claim 47, which comprises 0.1 to 0.8%, by weight relative to the total weight of the processed cheese, of at least one anionic emulsifier.

56. The processed cheese according to claim 47, which comprises 0.2 to 0.6% of at least one anionic emulsifier.

57. The processed cheese according to claim 47, wherein said anionic emulsifier is a monoglyceride esterified with an organic acid, or an ester of a lactic acid esterified with fatty acids, or a mixture thereof.

58. The processed cheese according to claim 47 wherein said anionic emulsifier is a diacetyl tartaric acid ester of monoglyceride (DATEM), a sodium stearoyl lactylate (SSL) or a calcium stearoyl lactylate (CSL).

59. The processed cheese according to claim 47, which further comprises 0.05 to 5% of one or more than one carrageenan.

60. The processed cheese according to claim 47, said processed cheese having a fat in solids content in the range 5 to 70%.

61. The method according to claim 32, wherein the processed cheese obtained at step b) or c) displays an increased firmness.
